(19) United States
(12) Patent Application Publication
(10) Pub. No.: US 2025/0303925 A1
(43) Pub. Date: Oct. 2, 2025

(54) CONTROL APPARATUS FOR SECONDARY BATTERY

(71) Applicant: Mazda Motor Corporation, Aki-gun (JP)

(72) Inventors: Takashi Yamamoto, Aki-gun (JP); Keisuke Yamashita, Aki-gun (JP)

(21) Appl. No.: 19/062,451

(22) Filed: Feb. 25, 2025

(30) Foreign Application Priority Data
Mar. 29, 2024 (JP) 2024-056017

(51) Int. Cl. B60L 58/18; B60L 7/18; B60L 58/12; H02J 7/00

(52) U.S. Cl. CPC B60L 58/18; B60L 7/18; B60L 58/12; H02J 7/0047; H02J 7/0063; H02J 7/00712; H02J 7/007194; B60L 2250/16

(57) ABSTRACT

To restrain deterioration of a secondary battery, a control apparatus for a secondary battery includes: a state sensor that includes sensors configured to detect at least one of a state of charge (SOC) and a temperature of the secondary battery; and a controller that determines, based on a detection signal of the sensors, whether or not a first condition is fulfilled that is fulfilled when at least one of the SOC and the temperature is continuously not less than a predetermined value, and controls a charge/discharge current of the secondary battery based on the determination result, and the controller determines, in disconnection of electric power supply to a driving source, whether or not the first condition is fulfilled, and restricts, when it is determined that the first condition is fulfilled, a magnitude of the charge/discharge current more than in the case where the first condition is not fulfilled.

### TECHNICAL FIELD

The present disclosure relates to a control apparatus for a secondary battery.

### BACKGROUND ART

For example, JP2020-517080A discloses a battery module applicable to an electric vehicle (EV), a hybrid electric vehicle (HEV), and the like.

Specifically, the battery module of JP2020-517080A mentioned above includes a cell assembly, an upper plate and a lower plate, and a pair of side plates. Herein, the cell assembly includes a plurality of pouch-type battery cells arranged and stacked in one direction. The upper and lower plates respectively cover the upper portion and the lower portion of the cell assembly. Further, the pair of side plates are press fitted or fitted to both ends of the upper plate and the lower plate.

According to JP2020-517080A mentioned above, provision of the side plates as mentioned above results in formation of a gas capturing space. The formation of the gas capturing space enables the capture of gas generated by decomposition, when the inner electrolyte is decomposed due to repetition of charge and discharge. This can prevent a rapid pressure rise in the battery module and resulting deformation.

### SUMMARY OF INVENTION

### Problems to be Solved by the Invention

When a secondary battery for vehicles is left outdoors or the like, there is a possibility that gas as disclosed in JP2020-517080A mentioned above accumulates in the battery cells constituting the secondary battery. It is considered that such generation of the gas becomes more significant in situations such as at a higher temperature and at a higher state of charge (SOC).

When the gas accumulates in the battery cells, the gas can occasionally prevent the chemical reactions in the battery cells. This may cause the reaction areas in the battery cells to decrease and internal resistance to rise. This is disadvantageous from various viewpoints such as the battery capacity.

The present disclosure has been made in view of such circumstances, and an object thereof is to restrain deterioration of a secondary battery.

### Means for Solving the Problems

A first aspect of the present disclosure relates to a control apparatus for a secondary battery, the secondary battery including a plurality of battery cells, the control apparatus supplying electric power from the plurality of battery cells to a driving source of a vehicle. The control apparatus includes: a state sensor that includes sensors configured to detect at least one of a state of charge (SOC) and a temperature of the secondary battery; and a controller that determines, based on a detection signal of the sensors, whether or not a first condition is fulfilled, the first condition being fulfilled when at least one of the SOC and the temperature is continuously not less than a predetermined value, and controls a charge/discharge current of the secondary battery based on a result of a determination. The controller determines, in disconnection of electric power supply to the driving source, whether or not the first condition is fulfilled, and restricts, when it is determined that the first condition is fulfilled, a magnitude of the charge/discharge current more than in a case where the first condition is not fulfilled.

The term “charge/discharge current” designates at least one of a charge current and a discharge current.

The inventors have tried to discharge gas accumulating in the battery cells to the outside through the electrodes, by causing the battery cells to expand and contract through charge and discharge. However, this is disadvantageous, as electrodeposition of Li and the like occurs depending on a setting of what is called a “C-rate.” In other words, a system that discharges gas from the inside of the battery cells without causing deposition, if any, is advantageous.

To this end, the inventors have employed a configuration to restrict high rate charge and discharge when the first condition which implies generation of gas is satisfied, as in the first aspect. Thus the gas can be discharged from the inside of the battery cells without causing deposition. As a result, deterioration of the secondary battery can be restrained.

Moreover, according to a second aspect of the present disclosure, the first condition may not be fulfilled when an internal resistance value of the secondary battery continuously decreases; and when restriction of the magnitude of the charge/discharge current is started, the controller may acquire the internal resistance value of the secondary battery after the driving source is started, may update the determination of the first condition based on an acquired value of the internal resistance value, and may cancel, when the first condition is not fulfilled after update, the restriction of the magnitude of the charge/discharge current.

It is considered that, when gas accumulates in the battery cells, the gas prevents the chemical reactions, and consequently, the internal resistance value of the secondary battery increases. In other words, it is considered that, when the gas is discharged from the battery cells, the internal resistance value decreases. It is considered that, when the internal resistance value continuously decreases, the magnitude of the charge/discharge current no longer needs to be restricted.

Therefore, according to the second aspect, after the start of the driving source with electric power, the controller monitors a change in the internal resistance value, and redetermines the first condition based on the internal resistance value changing over time. Thus a period during which the magnitude of the charge/discharge current is restricted can be made as short as possible. Thus both restraining the deterioration of the secondary battery and restraining the charge period of the secondary battery can be made mutually inclusive.

Moreover, according to a third aspect of the present disclosure, the driving source may be a motor that is able to perform a powering operation and a regenerative operation, and the controller may restrict the magnitude of the charge/discharge current by restricting a regenerative current generated with the regenerative operation to be not more than a predetermined upper limit.

According to the third aspect, the controller restricts the magnitude of the charge/discharge current (in particular, the charge current) from a viewpoint different from supplying electricity from power supply equipment to the vehicle. The deterioration of the secondary battery can be restrained without obstructing electricity supply from the outside.

Moreover, according to a fourth aspect of the present disclosure, between fast charging, in which the vehicle receives an electric power supply not less than a predetermined electric power, and normal charging, in which the vehicle receives an electric power supply less than the predetermined electric power, the vehicle is able to receive electricity from the power supply equipment at least through fast charging in order to charge the secondary battery; and the controller may restrict the magnitude of the charge/discharge current by restricting electricity supply through the fast charging.

According to the fourth aspect, by restricting the fast charging, the controller restricts the magnitude of the charge current (in particular, the charge current). Thus the deterioration of the secondary battery can be restrained while the normal charging is allowed.

Moreover, according to a fifth aspect of the present disclosure, the control apparatus may include a notification unit that is electrically connected to the controller and notifies an occupant of the vehicle of information, and the notification unit may determine presence or absence of an indication that the first condition will be fulfilled based on the detection signal of the state sensor, and when it is determined that there is the indication, may notify the occupant of information indicating that the first condition is going to be fulfilled.

According to the fifth aspect, before the magnitude of the charge/discharge current is actually restricted as a result of the first condition being fulfilled, the occupant is notified of the indication of this. Thus the frequency at which the magnitude of the charge/discharge current is restricted can be restrained, usability of the vehicle can be improved, and simultaneously, this is also advantageous to restraining the deterioration of the secondary battery by guiding the occupant to not allow fulfillment of the first condition.

Moreover, according to a sixth aspect of the present disclosure, the plurality of battery cells, each having a plate shape, may be disposed to line up in a vehicle longitudinal direction in a state of being bound from both front and rear sides of the plate shape, each of the plurality of battery cells may be disposed such that long sides thereof extend in a vehicle transverse direction, short sides thereof extend in a vehicle vertical direction, and a thickness thereof extends in the vehicle longitudinal direction, a length of the long sides of each of the plurality of battery cells may exceed 50% of a vehicle width of the vehicle, and at both ends of the long sides of each of the plurality of battery cells, tabs corresponding to a positive electrode and a negative electrode of the battery cell may be disposed.

In general, gas accumulating in the battery cells is discharged outside the cells via the tabs with binding forces acting from both sides, the front and the rear, of each battery cell. However, in the case of the battery with a high aspect ratio as in the sixth aspect, the acting binding forces per unit area become weak by widened surface areas of the front and the rear sides. Meanwhile, since the tabs are normally provided at both ends of the battery cell, the magnitude of the tabs is not necessarily widened relative to the surface area of each battery cell.

The gas accumulating in the battery cells becomes difficult to discharge outside the cells when both the binding forces per unit area become weak and the sizes of the tabs do not become sufficiently large.

The first aspect is particularly effective for such high aspect ratio battery cells.

### Advantageous Effect of Invention

As described above, according to the present disclosure, deterioration of a secondary battery can be restrained.

### BRIEF DESCRIPTION OF DRAWINGS

FIG. 1 is a schematic diagram exemplarily showing a vehicle.

FIG. 2 is a perspective view exemplarily showing a configuration of a secondary battery mounted on the vehicle.

FIG. 3A is a perspective view exemplarily showing a configuration of a battery cell.

FIG. 3B is a sectional view exemplarily showing a configuration of the battery cell.

FIG. 4 is a block diagram exemplarily showing a configuration of a control apparatus for a secondary battery.

FIG. 5 is a functional block diagram exemplarily showing a configuration of the control apparatus for a secondary battery.

FIG. 6 is a diagram for explaining fulfillment or non-fulfillment of a second condition.

FIG. 7 is a diagram for explaining a change in an evaluation value.

FIG. 8 is a flowchart exemplarily showing processing related to a low rate control.

FIG. 9 is a flowchart exemplarily showing processing related to the low rate control.

FIG. 10 is a diagram for explaining relationship between high and low aspect ratios of the secondary battery and an amount of generation of gas.

FIG. 11 is a diagram for explaining relationship between an execution time of the low rate control and the amount of generation of gas.

FIG. 12 is a diagram for explaining relationship between the execution time of the low rate control and a change in an internal resistance value.

FIGS. 13-16 are flow charts of method of controlling a secondary battery, according to one example implementation of the present disclosure.

### MODE FOR CARRYING OUT THE INVENTION

Hereafter, embodiments of the present disclosure will be described based on the drawings. Notably, the following description is exemplary illustrations.

### 1. Overall Configuration

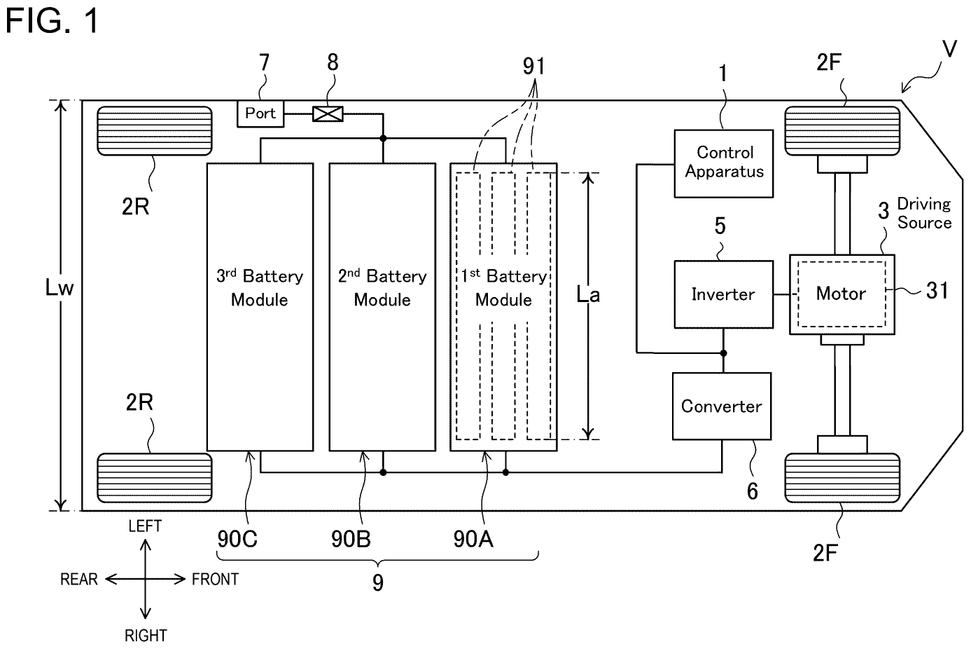

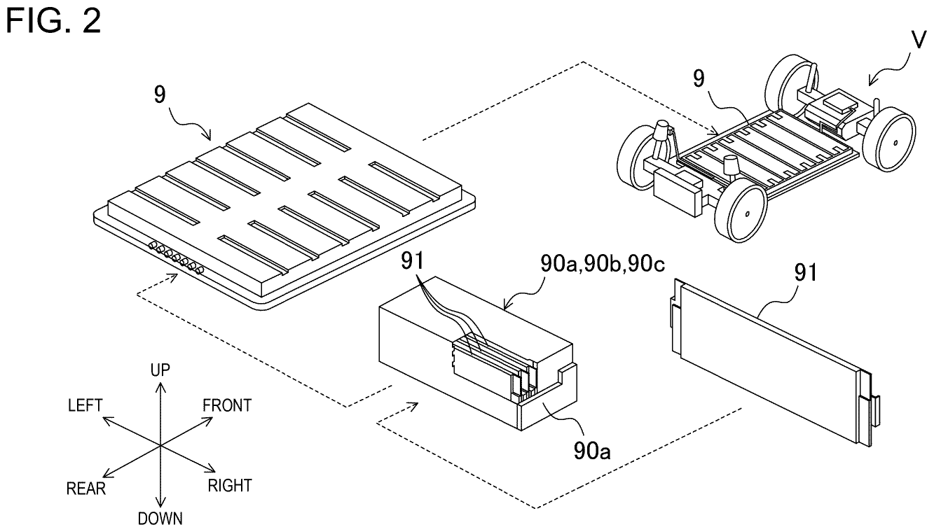

FIG. 1 is a schematic diagram exemplarily showing a vehicle V. FIG. 2 is an exploded view exemplarily showing a configuration of a secondary battery 9 mounted on the vehicle V. A control apparatus 1 for the secondary battery 9 according to the present embodiment is mounted on the vehicle V shown in the figures. The vehicle V is an automobile that can travels using electric power.

Specifically, the vehicle V according to the present embodiment is what is called an electric vehicle (EV). The vehicle V may be a hybrid vehicle utilizing electric power as a primary energy source, such as a plugin hybrid vehicle (PHEV).

Hereafter, a front-rear direction with a vehicle body of the vehicle V being as a reference is called “vehicle front-rear direction” or simply “front-rear direction”. As exemplarily shown in FIG. 1 and FIG. 2, the “front” stated here means a direction where the vehicle V advances, and the “rear” means a direction where the vehicle V reverses.

Likewise, a right-left direction with the vehicle body of the vehicle V being as the reference is called “vehicle width direction” or simply “right-left direction”. As exemplarily shown in FIG. 1 and FIG. 2, the “right” stated here means a right side as viewed from an occupant of the vehicle V, and the “left” means a left side as viewed from the occupant.

Likewise, an up-down direction with the vehicle body of the vehicle V being as the reference is called “vehicle height direction” or simply “up-down direction”. As exemplarily shown in FIG. 2, being on the “up” side stated here means being in a direction as viewed from the occupant of the vehicle V, being in a direction that is perpendicular to a road surface on the vehicle V and in which a thing is separating from the road surface. Meanwhile, being on the “down” side stated here means being in a direction as viewed from the occupant of the vehicle V, being in a direction that is perpendicular to the road surface on the vehicle V and in which a thing is coming close to the road surface.

The secondary battery 9 in the present embodiment is configured as a battery system including a plurality of battery cells 91. Further, the control apparatus 1 for the secondary battery 9 in the same embodiment means an apparatus that supplies electric power from the plurality of battery cells 91 to a driving source 3 of the vehicle V. The control apparatus 1 can be rephrased as a control apparatus/control system that, by supplying electric power to the driving source 3 of the vehicle V, causes the driving source 3 to generate a driving force of the vehicle V.

Specifically, the vehicle V according to the present embodiment includes a plurality of wheels 2F, 2R, a motor 31 being an example constituting the driving source 3, an inverter 5, a converter 6, a charging port 7, an in-vehicle charger 8, the secondary battery 9, and a control apparatus 1, which may include, for example, a controller 100. Each of these elements is mounted or disposed on the vehicle V.

The plurality of wheels 2F, 2R includes two front wheels 2F and two rear wheels 2R. Namely, the vehicle V according to the present embodiment is a four-wheeled automobile. The driving source 3 is coupled to all of or part of the plurality of wheels 2F, 2R via shaft(s) and the like.

The driving source 3 includes the motor 31 that can perform a powering operation and a regenerative operation. For example, the motor 31 is a permanent magnet-type synchronous motor that is driven with three-phase alternating current.

In the powering operation, the motor 31 receives electric power supply from the secondary battery 9 to rotate. This rotation generates the traveling driving force of the vehicle V. When the motor 31 rotates in the powering operation, the rotation is transmitted via a not-shown shaft. The rotation transmitted via the shaft rotates at least some of the wheels 2F, 2R, such as the two front wheels 2F. By the at least some of the wheels 2F, 2R rotating, the vehicle V travels.

Moreover, the motor 31 not only functions as a driving source in the powering operation but also can be caused to function as a generator in the regenerative operation. The motor 31 is electrically connected to the secondary battery 9 via the inverter 5 and the converter 6. This connection is used for both the powering operation and the regenerative operation as mentioned later in detail.

In the powering operation, the converter 6 steps down high voltage direct current (DC) electric power supplied from the secondary battery 9 into DC electric power having a predetermined base voltage. The converter 6 inputs the DC electric power after the step-down into the inverter 5. The inverter 5 converts the DC electric power supplied from the secondary battery 9 via the converter 6 into three-phase alternating current having phases different from one another. The inverter 5 supplies the alternating current after the conversion to the motor 31. By supplying the alternating current to the motor 31, the motor 31 rotates as mentioned above.

In the regenerative operation, the inverter 5 converts alternating current (AC) electric power generated by rotation of the motor 31 into DC electric power. The inverter 5 inputs the DC electric power after the conversion into the converter 6. The converter 6 boosts the DC electric power input from the motor 31 via the inverter 5. The converter 6 charges the secondary battery 9 with the DC electric power after the boosting.

The secondary battery 9 includes one or a plurality of (in the present embodiment, a plurality of) battery modules 90A-C, each of which includes the plurality of battery cells 91 mentioned above.

For example, the secondary battery 9 according to the present embodiment includes a first module 90A, a second module 90B, and a third module 90C constituting the plurality of battery modules 90A-C.

Herein, the plurality of battery modules 90A-C according to the present embodiment line up in the front-rear direction as shown in FIG. 1. Each of the battery modules 90A-C lining up in the vehicle front-rear direction is set to have, for example, three times or more the length in the vehicle width direction (battery longitudinal direction) as compared with the length in the vehicle height direction (battery transverse direction). The length of each battery module 90 in the vehicle width direction is set to a length of 70% or more a vehicle width Lw of the vehicle V.

Moreover, for example, the plurality of battery modules 90A-C are connected to one motor 31 in parallel. Alternatively, the plurality of battery modules 90A-C may each be individually connected to the motor 31 via converter 6.

Each battery module 90 is connected to the charging port 7 via the in-vehicle charger 8. The charging port 7 can also be rephrased as a charging inlet.

The vehicle V is configured to be able to receive electricity at least through fast charging between fast charging and normal charging. In particular, the vehicle V according to the present embodiment is configured to be able to receive electricity through both fast charging and normal charging.

Herein, the fast charging means charging standards for receiving electric power supply not less than predetermined electric power from power supply equipment to charge the secondary battery 9. Examples of the fast charging include CHAdeMO (registered trademark), CCS1, CCS2, GB/T, and Supercharger (TPC). The “predetermined electric power” stated here may be 10 kW, for example. Moreover, charging that has a C-rate not less than 1.0 may be categorized into the “fast charging” in the present embodiment.

Meanwhile, the normal charging means charging standards for receiving electric power supply less than the predetermined electric power from the power supply equipment to charge the secondary battery 9. Examples of the normal charging include J1772 (Type1), J1772 (Type2), and Mennekes (registered trademark). Moreover, charging that has a C-rate less than 1.0 may be categorized into the “normal charging” in the present embodiment.

Details being omitted, one or two charging ports 7 are prepared for each vehicle V. To each charging port 7, a connector of power supply equipment can be connected. This connection can supply electricity from the power supply equipment to the vehicle V via the charging port 7.

For example, when electric power supplied to the vehicle V is alternating current, after converted into direct current by the in-vehicle charger 8, the electric power is supplied to the battery modules 90A-C of the secondary battery 9.

Moreover, when electric power supplied to the vehicle V is direct current, at least without conversion between alternating current and direct current, the electric power is supplied to the battery modules 90A-C of the secondary battery 9.

Notably, the in-vehicle charger 8 according to the present embodiment is configured to restrict electricity supply through the fast charging, based on a control signal from the controller 100, mentioned later. The in-vehicle charger 8 performs the restriction of electricity supply by prohibiting or disconnecting electricity supply through the fast charging and/or by lowering a magnitude of a current (charge current) flowing in electricity supply.

### 3. Details of Secondary Battery

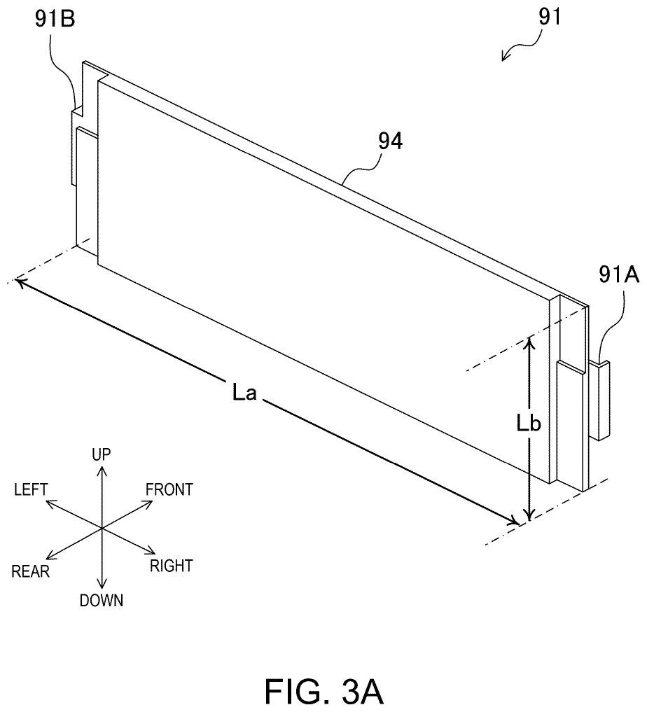

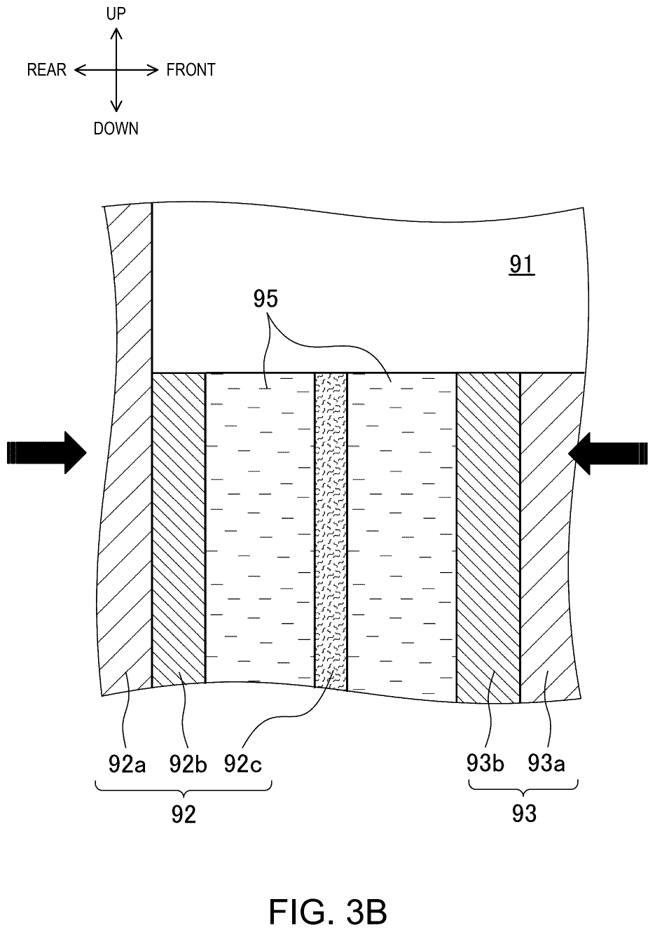

FIG. 3A is a perspective view exemplarily showing a configuration of the battery cell 91. FIG. 3B is a sectional view exemplarily showing the configuration of the battery cell 91. The section in FIG. 3B corresponds to a section taken along the longitudinal direction and the vertical direction.

As shown in FIG. 2, each of the plurality of battery cells 91 constituting each battery module 90 has a plate shape. These battery cells 91 are housed in a box-like module container 90a in the state of lining up in the front-rear direction.

In detail, in each battery module 90, the plurality of battery cells 91 are disposed such that their longitudinal directions go along the vehicle width direction, their transverse directions go along the vehicle height direction, and their thickness directions go along the vehicle front-rear direction. Such disposition can make the dimension of each battery module 90 in the vehicle width direction (longitudinal direction) long while making the dimension thereof in the vehicle height direction as short as possible.

Moreover, with the module container 90a or a separate member independent of the module container 90a, an external force that binds these in the vehicle front-rear direction (refer to black arrows in FIG. 3B) acts on the plurality of battery cells 91 housed in each module container 90a.

Further, as shown in FIG. 3A, a dimension La (length) of each of the plurality of battery cells 91 in the battery longitudinal direction is longer than a dimension Lb (width) thereof in the battery transverse direction. In the case of the present embodiment, the dimension La in the battery longitudinal direction is three times or more of the dimension Lb in the battery transverse direction. Each battery cell 91 is a high aspect ratio battery cell. Each battery cell 91 can be referred to as what is called a blade battery or a blade cell.
In detail, as shown in FIG. 1, the dimension La of each of the plurality of battery cells 91 exceeds 50% of the vehicle width Lw of the vehicle V. In other words, the plurality of battery cells 91 extend to be long in the transverse direction such that they cannot be adjacent to each other in the transverse direction. The dimension La of each of the plurality of battery cells 91 in the battery longitudinal direction preferably exceeds 70% of the vehicle width Lw.

Moreover, tabs 91A and 91B corresponding to a positive electrode and a negative electrode of each of the plurality of battery cells 91 are disposed at both long ends of the battery cell.

More in detail, each battery cell 91 includes alternately stacked negative electrode sheets 92 and positive electrode sheets 93. The alternately stacked negative electrode sheets 92 and the positive electrode sheets 93 are housed in a cell container 94 shown in FIG. 3A, as shown in FIG. 3B. Each battery cell 91 is what is called a lithium ion battery using movement of lithium ions between electrodes.

As shown in FIG. 3B, the negative electrode sheet 92 has a current collector 92a, an active material 92b, and a separator 92c. The current collector 92a and the active material 92b constitute what is called a “negative electrode”. The negative electrode sheet 92 extends in the vehicle width direction to be long.

The current collector 92a is a plate material with a small thickness extending in a direction perpendicular to the stacking direction. One of two ends of the current collector 92a protrudes outside the cell container 94, for example, through an opening positioned on one long side of the cell container 94 in the longitudinal direction. This protrusion portion constitutes the tab 91A on the negative electrode side.

The active material 92b is applied onto a surface of the current collector 92a. The negative electrode including the active material 92b and the current collector 92a faces the positive electrode sheet 93, for example, via the separator 92c.

As shown in FIG. 3B, the positive electrode sheet 93 has a current collector 93a and an active material 93b. The current collector 93a and the active material 93b constitute what is called a “positive electrode”. The positive electrode sheet 93 extends in the vehicle width direction to be long.

The current collector 93a is a plate material with a small thickness extending in a direction perpendicular to the stacking direction. One of two ends of the current collector 93a protrudes outside the cell container 94, for example, through an opening positioned on the other long side of the cell container 94 in the longitudinal direction. This protrusion portion constitutes the tab 91B on the positive electrode side.

The active material 93b is applied onto a surface of the current collector 93a. The positive electrode including the active material 93b and the current collector 93a faces the active material 92b and the current collector 92a of the negative electrode sheet 92, for example, via the separator 92c.

Moreover, an electrolytic liquid 95 is encapsulated in the cell container 94. Lithium ions pass between the electrodes via the electrolytic liquid 95. By causing current to flow into the battery cell 91 from the outside, lithium ions move to the negative electrode side. The movement of lithium ions generates a potential difference between the negative electrode and the positive electrode. The potential difference being generated by electric power supply from the outside is equivalent to the battery cell 91 being charged.

Moreover, the potential difference mentioned above is relieved by lithium ions moving from the negative electrode side to the positive electrode side. At that time, current is to flow from the battery cell 91 to the outside. The potential difference being relieved by electric power supply to the outside is equivalent to the battery cell 91 discharging.

### 2. Configuration of Control Apparatus

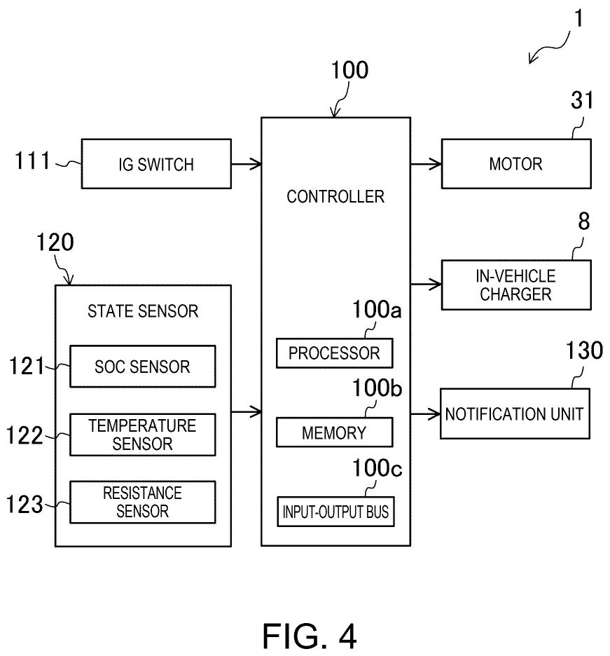

FIG. 4 is a block diagram exemplarily showing a configuration of the control apparatus 1 for the secondary battery 9. The control apparatus 1 includes switches such as an ignition (IG) switch 111, a state sensor 120 including for example a state of charge (SOC) sensor 121, a notification unit 130, and the controller 100.

The IG switch 111 is a switch for supplying electricity to the motor 31 of the vehicle V. The IG switch 111 is electrically connected to the controller 100. When the IG switch 111 is manipulated, an electric signal for switching an operation mode of the vehicle V between “IG-ON” and “IG-OFF” is input into the controller 100. The IG switch 111 can also be called a power switch or an ignition switch.

The “IG-OFF” is a mode used in a non-traveling state of the vehicle V such as during parking or while the occupant leaves the vehicle V (particularly during power source disconnection of the driving source 3). In this mode, charge and discharge of the secondary battery 9 are restricted. In other words, in this mode, the secondary battery 9 and the driving source 3 is electrically separated (the electric connection therebetween is disconnected). As a result, both electric power supply from the secondary battery 9 to the driving source 3 and electric power supply from the driving source 3 to the secondary battery 9 are to be disconnected.

The “IG-ON” is a mode mainly used in a traveling state of the vehicle V (particularly while power is turned on for the driving source 3). In this mode, charge and discharge of the secondary battery 9 are allowed. In other words, in this mode, electricity is turned on for the secondary battery 9 and the driving source 3 (they are electrically connected). As a result, both electric power supply from the secondary battery 9 to the driving source 3 and electric power supply from the driving source 3 to the secondary battery 9 are to be allowed.

The state sensor 120 includes sensors that are configured to detect at least one of an SOC (State Of Charge) and a temperature of the secondary battery 9. The state sensor 120 is electrically connected to the controller 100. Detection signals of the sensors are input into the controller 100. In particular, in the present embodiment, they are configured to detect individually either the SOC or the temperature of the secondary battery 9.

In detail, the state sensor 120 according to the present embodiment includes at least the SOC sensor 121 and a temperature sensor 122. The SOC sensor 121 and the temperature sensor 122 are electrically connected to the controller 100.

More in detail, the SOC sensor 121 detects the SOC of the secondary battery 9. The temperature sensor 122 detects the temperature of the secondary battery 9. The temperature sensor 122 may detect a physical quantity with a correlation with the temperature of the secondary battery 9, such as a peripheral temperature of the secondary battery 9 or an outside air temperature of the vehicle V. The SOC sensor 121 and the temperature sensor 122 input their detection signals into the controller 100.

Specifically, the SOC sensor 121 outputs a signal corresponding to the SOC, based on a measurement value of an open circuit voltage (Open Circuit Voltage: OCV). The SOC sensor 121 can include a voltage sensor that can measure a circuit voltage. The SOC sensor 121 is electrically connected to the controller 100. The SOC sensor 121 inputs its detection signal into the controller 100.

The state sensor 120 further includes a resistance sensor 123 that measures an internal resistance of the secondary battery 9. The resistance sensor 123 is electrically connected to the controller 100. A detection signal of the resistance sensor 123 is input into the controller 100.

The notification unit 130 is electrically connected to the controller 100. The notification unit 130 is configured to notify the occupant of the vehicle V of information related to processing by the controller 100 mentioned later.

In detail, the notification unit 130 according to the present embodiment includes what is called a Data Communication Module (DCM). The notification unit 130 can notify the occupant of information via a portable terminal of the occupant, such as a smartphone or a tablet. The information that the occupant is notified of may be color vision information in the form of a display on a screen or may be voice information in the form of an output from a loudspeaker.

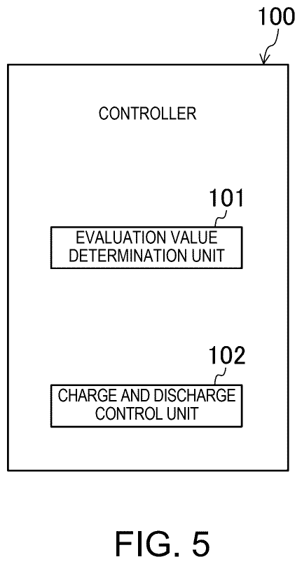

The controller 100 includes hardware such as a processor 100a, a memory 100b, and an input-output bus 100c and software such as a database and a control program. For functional elements related to the latter software, refer to FIG. 5. That is, each of the units 101-102 in controller 100 may be software stored in the memory 100b and executable by the processor 100a to achieve its respective function.

Notably, while one controller 100 is shown as an example of what constitutes the control apparatus 1 in FIG. 4, across various control modules mounted on the vehicle V, a module (PCM) for controlling the driving source 3, for example, may constitute the controller 100.

Based on signals input from the switches and the sensors mentioned above, the controller 100 performs processing related to charge and discharge of the secondary battery 9. In order to perform such processing, the controller 100 includes a plurality of functional blocks shown in FIG. 5.

### 4. Details of Controller

As shown in FIG. 5, the controller 100 includes an evaluation value determination unit 101 and a charge and discharge control unit 102. The evaluation value determination unit 101 determines whether or not a first condition is fulfilled. Based on the determination result by the evaluation value determination unit 101, the charge and discharge control unit 102 controls a charge/discharge current of the secondary battery 9. Herein, the term, charge/discharge current, designates at least one of a charge current and a discharge current. In the case of the present embodiment, the controller 100 is configured to control at least the charge current as the charge/discharge current.

Herein, the first condition is a condition that is fulfilled when at least one of the SOC and the temperature is continuously not less than a predetermined value. In particular, the first condition according to the present embodiment is set to be fulfilled when both the SOC and the temperature are continuously not less than predetermined values.

When the SOC and the temperature of the secondary battery 9 are high, as compared with the case where they are low, gas more tends to be generated in the battery cells 91. Moreover, when the SOC and the temperature of the secondary battery 9 continue to be high, it is considered that, in accordance with the continuing time, the gas accumulates in the battery cells 91.

Accordingly, by determining the first condition, the presence or absence of generation of gas in the battery cells 91 and an amount of generation of the gas can be determined.

First, in IG-OFF, for example, when the vehicle V is in a non-traveling state, the evaluation value determination unit 101 determines whether or not the first condition is fulfilled. In the present embodiment, determination of fulfillment or non-fulfillment of the first condition is made with an evaluation value mentioned later in detail.

In detail, the evaluation value determination unit 101 monitors transitions (in particular, transitions over time) of the SOC and the temperature. Based on the values of the SOC and the temperature, the evaluation value determination unit 101 determines whether or not a second condition is fulfilled.

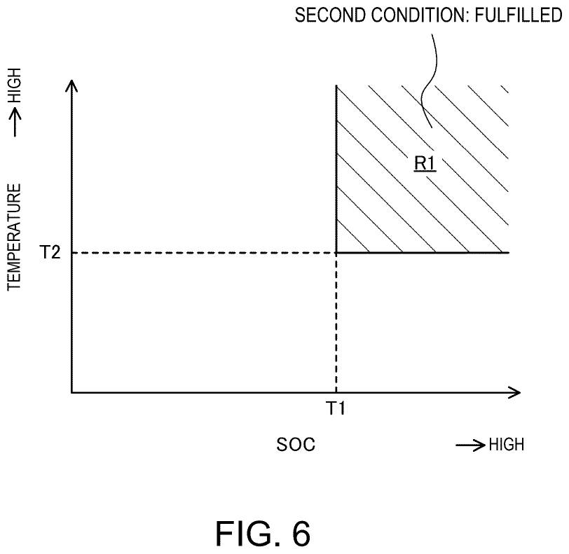

Herein, as exemplarily shown as a region R1 in FIG. 6, the second condition is a condition that is fulfilled when the SOC is not less than a first threshold T1 and the temperature is not less than a second threshold T2.

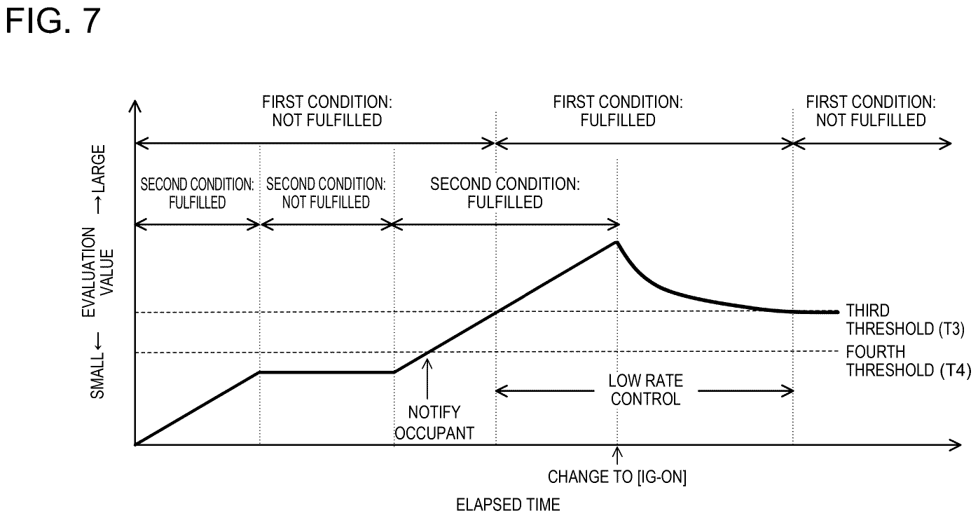

When the second condition is fulfilled, the evaluation value determination unit 101 calculates an evaluation value that increases in accordance with a fulfillment period of the second condition, in other words, the period during which the second condition is fulfilled. This evaluation value is larger as the fulfillment period of the second condition is longer. For example, as shown in FIG. 7, the evaluation value may be an integrated value that starts to be counted from the time point when the second condition is fulfilled and is being chronologically counted up during the period during which the second condition is fulfilled. As shown in the figure, when the second condition is not fulfilled, the evaluation value is not counted up. When the motor 31 is driven at IN-ON, the counting of the evaluation value may be stopped since the vehicle V is no longer in a non-traveling state.

That the evaluation value is large means that the second condition is continuously fulfilled over a relatively long period. That the evaluation value is small means that the second condition is fulfilled only for a relatively short period. It is considered that the evaluation value has a positive correlation with an amount of gas accumulated in the battery cells 91.

When the evaluation value exceeds a predetermined third threshold T3, the evaluation value determination unit 101 determines that both the SOC and the temperature are continuously not less than the predetermined values. Namely, when the evaluation value exceeds the predetermined third threshold T3, the evaluation value determination unit 101 determines that the first condition is fulfilled.

Then, when the evaluation value determination unit 101 determines that the first condition is fulfilled, the charge and discharge control unit 102 performs a predetermined low rate control (refer to FIG. 7). Herein, the low rate control refers to processing of restricting the magnitude of the charge/discharge current more than in the case where the first condition is not fulfilled.

Notably, as mentioned above, the charge and discharge control unit 102 according to the present embodiment is configured to restrict at least the magnitude of the charge current as the charge/discharge current. Nevertheless, the present disclosure is not limited to such a configuration. The charge and discharge control unit 102 may restrict at least a magnitude of the discharge current in place of the charge current. When the magnitude of the discharge current is restricted, by switching a circuit structure of electric circuits (circuits which the discharge current flows through) connecting the battery modules 90A-C and the converter 6, the charge and discharge control unit 102 may decrease the number of the battery modules 90A-C, that is, the battery cells 91 connected to the converter 6. Otherwise, by increasing the amount of step-down at the converter 6, the charge and discharge control unit 102 may restrict the magnitude of the discharge current.

Returning to the description of the present embodiment, when the low rate control is performed, the charge and discharge control unit 102 according to the embodiment decreases the magnitude of the charge/discharge current more than in the case where the first condition is not fulfilled. By decreasing the magnitude of the charge/discharge current, at least the charge out of the charge and discharge will be performed at a relatively low C-rate.

More in detail, the charge and discharge control unit 102 restricts the C-rate when the low rate control is performed. When the C-rate is restricted, the discharge current, in addition to the charge current, will also be restricted. In this case, by performing the low rate control, the C-rate may decrease, for example, to be not more than 0.1 C.

Specifically, when the low rate control is performed, the charge and discharge control unit 102 according to the present embodiment restricts the magnitude (C-rate) of the charge/discharge current (in particular, the charge current) by restricting electricity supply through the fast charging. In this case, the electricity supply through the fast charging will be prohibited, and only the electricity supply through the normal charging will be allowed.

Moreover, in place of or in addition to restricting the electricity supply through the fast charging, the charge and discharge control unit 102 according to the present embodiment restricts the magnitude of the charge/discharge current (in particular, the charge current) by restricting a regenerative current generated with the regenerative operation of the motor 31 to be not more than a predetermined upper limit. In this case, by prohibiting the regenerative operation itself, the regenerative current may be restricted to zero.

With IG-ON characters such as during the traveling of the vehicle V, the evaluation value determination unit 101 moreover updates the determination of the first condition. By updating the determination of the first condition, the controller 100 cancels the low rate control by the charge and discharge control unit 102.

Herein, the first condition is set so as not to be fulfilled when an internal resistance value of the secondary battery 9 continuously decreases. It is considered that, when gas is generated in the battery cells 91, the internal resistance value rises along with decrease of the active surface area. The internal resistance value of the secondary battery 9 has a positive correlation with the amount of gas accumulated in the battery cells 91. Accordingly, by monitoring a change in the internal resistance value, a change of the amount of gas in the battery cells 91 can be estimated.

Moreover, as with the internal resistance value, the evaluation value used for determining the first condition also has the positive correlation with the amount of gas as mentioned above. Accordingly, the evaluation value and the internal resistance value can be associated with each other.

For example, the controller 100 has a map in which a change amount of the internal resistance value and the evaluation value are associated with each other. As shown in FIG. 7, based on the change in the internal resistance value after IG-ON, the controller 100 can update the evaluation value.

Therefore, when the low rate control is started, after the start of the driving source 3 (after IG-ON), the controller 100 according to the present embodiment estimates the internal resistance value of the secondary battery 9. Based on the estimated internal resistance value, the controller 100 updates the evaluation value.

After that, based on the evaluation value after the update, the controller 100 updates the determination of the first condition. When the first condition is then still fulfilled, the controller 100 continues the low rate control. On the other hand, when the first condition is not fulfilled after the update, the controller 100 cancels the low rate control (cancels restricting the magnitude of the charge/discharge current).

### 5. Specific Example of Processing by Controller

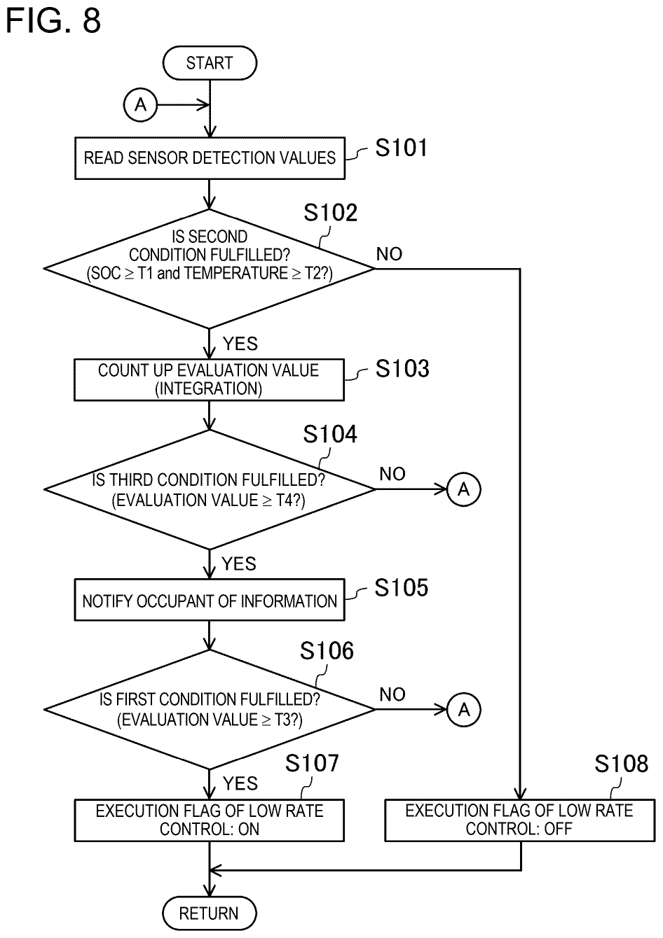

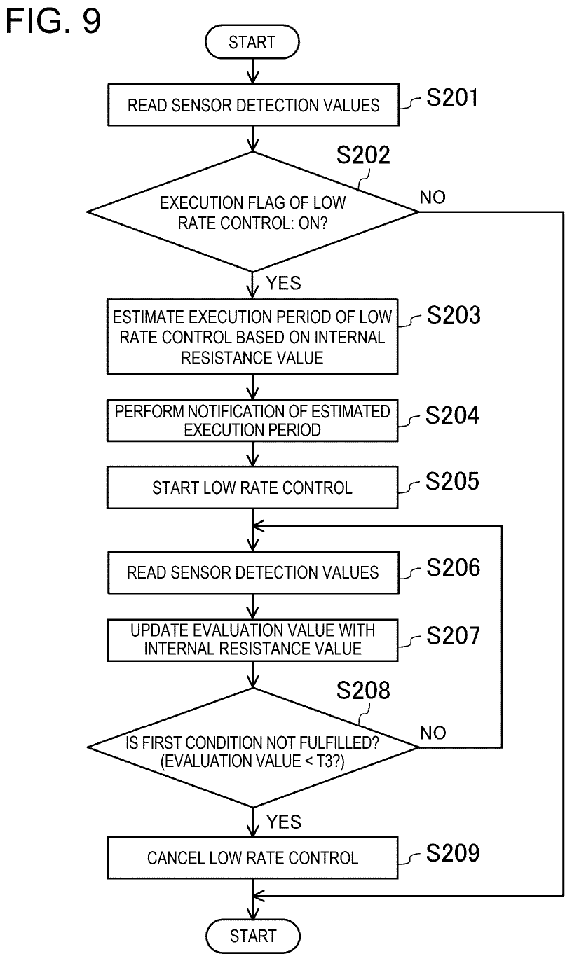

Each of FIG. 8 and FIG. 9 is a flowchart showing a specific example of processing related to the low rate control. The flow in FIG. 8 is mainly processing repeatedly performed before “IG-OFF” of the vehicle V. The flow in FIG. 9 is processing repeatedly performed after “IG-ON” of the vehicle V.

### (5-1. Processing in IG-OFF)

First, in step S101, the controller 100 reads the detection signals of the SOC sensor 121 and the temperature sensor 122.

Subsequently in step S102, based on the detection signals of the SOC sensor 121 and the temperature sensor 122, the controller 100 determines whether or not the second condition is fulfilled. Specifically, the controller 100 determines whether or not the SOC of the secondary battery 9 is not less than the first threshold (T1) and the temperature of the secondary battery 9 is not less than the second threshold (T2) (SOC≥T1 and Temperature≥T2?). The first threshold and the second threshold are preset and stored in the memory 100b of the controller 100 or the like.

When the determination in step S102 is YES, the controller 100 puts the control process forward to step S103. When the determination in step S102 is NO, the controller 100 puts the control process forward to step S108.

In the latter step S108, the controller 100 changes an execution flag of the low rate processing from ON to OFF or keeps it as OFF. When the execution flag is OFF, the controller 100 does not perform the low rate processing. After that, the controller 100 iteratively performs the flow in FIG. 8 sequentially from step S101.

On the other hand, in the former step S103, the controller 100 counts up the evaluation value.

In other words, as long as the second condition continues to be fulfilled in step S102, the controller 100 counts up the evaluation value in step S103 such that it increases in proportion to the fulfillment period.

On the other hand, when the second condition is not fulfilled during the count-up of the evaluation value, the controller 100 suspends the count-up of the evaluation value, and in step S108, sets the execution flag of the low rate processing to OFF.

In step S104 subsequent to step S103, based on the counted-up evaluation value, the controller 100 determines whether or not a third condition is fulfilled. Specifically, the controller 100 determines whether or not the evaluation value is not less than a fourth threshold (T4) (Evaluation Value≥T4?). The fourth threshold is a predetermined value at least less than the third threshold. The fourth threshold is preset and stored in the memory 100b of the controller 100 or the like. Determining fulfillment or non-fulfillment of the third condition is equivalent to determining the presence or absence of an indication that the first condition will be fulfilled.

When the determination in step S104 is YES (when there is the indication), the controller 100 puts the control process forward to step S105. When the determination in step S104 is NO, the controller 100 returns the control process to step S101.

Subsequently in step S105, the controller 100 notifies the occupant of information via the notification unit 130. The notification unit 130 notifies the occupant of information indicating that the first condition is going to be fulfilled. This information may be information implying that the first condition is going to be fulfilled without explicitly saying that the first condition is going to be fulfilled, such, for example, as that “the secondary battery is left for a long period at a high temperature and at a high SOC state” or that “the execution flag of the low rate processing is going to be ON soon”.

Notably, the process in step S105 may be performed only at the first fulfillment of the third condition or may be skipped when the execution flag of the low rate processing is ON.

Subsequently in step S106, based on the counted-up evaluation value, the controller 100 determines whether or not the first condition is fulfilled. Specifically, the controller 100 determines whether or not the evaluation value is not less than the third threshold (Evaluation Value≥T3?). The third threshold is preset and stored in the memory 100b of the controller 100 or the like.

When the determination in step S106 is YES, the controller 100 puts the control process forward to step S107. When the determination in step S106 is NO, the controller 100 returns the control process to step S101.

In step S107, the controller 100 changes the execution flag of the low rate processing from OFF to ON or keeps it as ON. When the execution flag is ON, the controller 100 is to perform the low rate processing after IG-ON.

After step S107, the controller 100 iteratively performs the flow in FIG. 8 until the IG switch 111 is manipulated and becomes IG-ON. For example, when the determination in step S102 is still established after the execution flag becomes ON, the controller 100 is to continue to count up the evaluation value.

(5-2. Processing after IG-ON)

After that, in the case of being “IG-ON”, first, in step S201, the controller 100 reads the detection signals of the resistance sensor 123.

Subsequently in step S202, the controller 100 determines whether or not the execution flag of the low rate control is ON, and only when the determination is YES, performs the processes in and after step S203.

Specifically, in step S203, the controller 100 estimates an execution period of the low rate control based on the internal resistance value. In the case of a general secondary battery, the negative electrodes of the battery cells 91 contract in discharging and expand in charging. Moreover, in consideration of the regenerative operation of the motor 31, the charge current that is generated through the regenerative operation is to flow in the secondary battery 9. Namely, even during the traveling of the vehicle V, the battery cells 91 are to repeat expansion and contraction.

As a result, gas accumulating in the battery cells 91 (in particular, gas caused by decomposition of the electrolytic liquid 95) is released from the tabs 91A and 91B. Thus obstruction of the chemical reactions due to the gas is relieved, and the internal resistance value of the battery cells 91 is to decrease gradually.

Based on the current internal resistance value, the controller 100 estimates the execution time required for the internal resistance to decrease down to an allowable value (predetermined value at which the low rate control becomes unnecessary). The controller 100 prestores a map or a model in which the execution period and the detection values of each of the sensors of state sensor 120 such as the resistance sensor 123 are associated with each other, and based on the stored content, estimates the execution time.

Subsequently in step S204, the controller 100 notifies the occupant of the estimated execution period. For example, this notification may be displayed on a display screen near a driver's seat (display unit for a tachometer and the like).

Subsequently in step S205, the controller 100 starts the low rate control. Thus magnitudes of various charge currents are restricted, such as the charge current in charging from power supply equipment and the charge current through the regenerative operation. The battery cells 91 can be caused to expand and contract without deposition of Li and the like due to high rate charging.

Subsequently in step S206, the controller 100 reads the detection signals of the state sensor 120 again. After driving of the motor 31 performed after IG-ON, the controller 100 acquires the internal resistance value.

Herein, when the battery cells 91 repeat the expansion and the contraction, gas in the cells is discharged. The influence of this will be reflected on the internal resistance value as mentioned above.

Therefore, subsequently in step S207, the controller 100 updates the evaluation value used for determining the first condition with the acquired internal resistance value. The controller 100 prestores a map in which an amount of decrease in the internal resistance value after the start of the low rate control and the evaluation value corresponding to the amount of decrease are associated with each other. This map is set such that the evaluation value also decreases as the internal resistance value decreases. The controller 100 updates the evaluation value, based on the amount of decrease of the internal resistance value.

Subsequently in step S208, based on the evaluation value after the update, the controller 100 updates the determination of the first condition. Then, when the first condition is not fulfilled after the update, the controller 100 puts the control process forward to step S209, and cancels the low rate control. Moreover, when the first condition is still fulfilled after the update, the controller 100 returns the control process to step S206.

In determination of whether or not the first condition is not fulfilled, a fifth threshold that is set to be lower than the third threshold may be used in place of the third threshold.

### 6. Gas Generated in Cells

When the secondary battery 9 for the vehicle V is left outdoors or the like, there is a possibility that, near the negative electrodes of the battery cells 91 constituting the secondary battery 9, gas caused by decomposition of the electrolytic liquid 95 accumulates. It is considered that such generation of the gas becomes more significant in situations such as at a higher temperature and at a higher SOC.

When the gas accumulates in the battery cells 91, the gas occasionally prevents the chemical reactions in the battery cells 91. This may cause the reaction areas of the battery cells 91 to decrease and the internal resistance to rise. This is disadvantageous from various viewpoints such as the battery capacity.

In general, gas accumulating in the battery cells 91 is discharged outside the cells 91 via the tabs 91A and 91B with binding forces acting from both sides, the front and the rear, of each battery cell 91 as indicated by the arrows in FIG. 3B.

However, in the case of the battery cell 91 with a high aspect ratio as in the present embodiment, the acting binding forces per unit area become weak by widened surface areas of the front and the rear sides. Meanwhile, since the tabs 91A and 91B are provided at both ends of the battery cell 91 as normal, the sizes of the tabs 91A and 91B are not necessarily widened relative to the surface area of each battery cell 91.

The gas accumulating in the battery cells becomes difficult to discharge outside the cells when both the binding forces per unit area become weak and the sizes of the tabs 91A and 91B do not become sufficiently large.

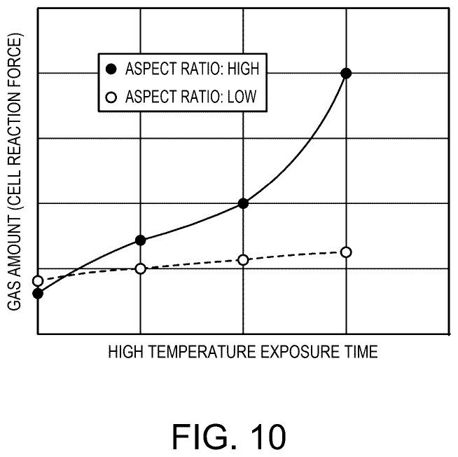

For example, the horizontal axis in FIG. 10 denotes an elapsed time during which the secondary battery 9 is exposed to a high temperature such that the first condition is fulfilled. The vertical axis in the figure denotes a cell reaction force of the secondary battery 9 by means of a load cell (reaction force against binding in the longitudinal direction). It is considered that the cell reaction force is proportional to the amount of gas in the battery cells 91. As shown in FIG. 10, the battery cells 91 that have a high aspect ratio exhibit a higher cell reaction force than the battery cells 91 that have a low aspect ratio.

In this situation, the inventors have tried to discharge gas accumulating in the battery cells to the outside through the electrodes of the battery cells 91, by causing the battery cells 91 to expand and contract through charge and discharge. However, this is disadvantageous, as electrodeposition of Li and the like occurs depending on a setting of what is called the C-rate. In other words, a system that discharges gas from the inside of the battery cells 91 without causing deposition, if any, is advantageous.

Therefore, the inventors have employed a configuration to restrict high rate charging by the low rate control when the first condition which implies generation of gas is satisfied as described with reference to FIG. 8. Thus the gas can be discharged from the inside of the battery cells 91 without causing deposition. As a result, deterioration of the secondary battery 9 can be restrained.

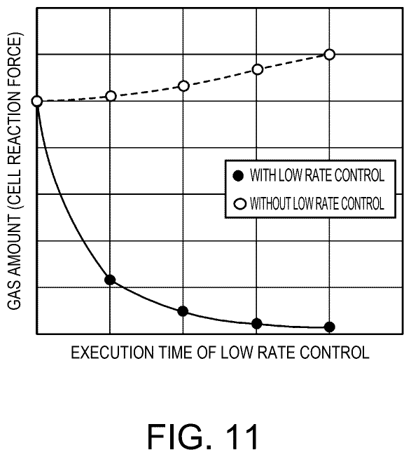

For example, the horizontal axis in FIG. 11 denotes an elapsed time from the start of the low rate control. The vertical axis means the same as in FIG. 10. As shown in FIG. 11, by performing the low rate control, the cell reaction force, accordingly, the amount of gas in the battery cells 91, can be reduced.

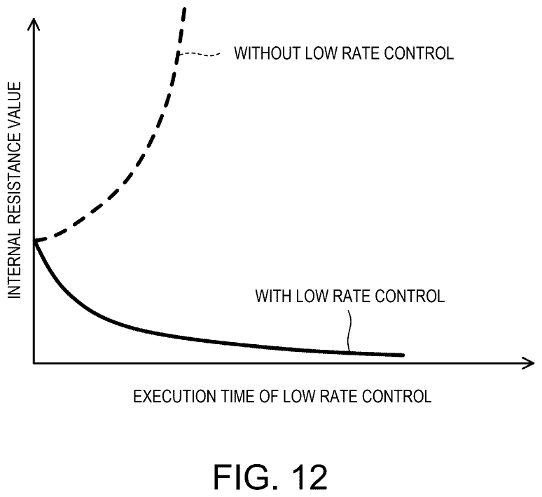

Moreover, it is considered that, when gas accumulates in the battery cells 91, the gas prevents the chemical reactions, and consequently, the internal resistance value of the secondary battery 9 increases. In other words, it is considered that, when the gas is discharged from the battery cells 91 through the low rate control, the internal resistance value gradually decreases over time, for example, as shown in FIG. 12. It is considered that, when the internal resistance value continuously decreases, the magnitude of the charge current no longer needs to be restricted.

Therefore, as described using FIG. 9, after the start of the driving source 3 with electric power, the controller 100 monitors a change in the internal resistance value, and redetermines the first condition based on the internal resistance value changing over time. Thus the execution period of the low rate control can be made as short as possible. Thus both restraining the deterioration of the secondary battery 9 and restraining the charge period of the secondary battery 9 can be made mutually inclusive.

Moreover, by performing the low rate control by restricting the magnitude of the charge current generated in the regenerative operation and/or restricting the fast charging, the deterioration of the secondary battery 9 can be restrained while the normal charging is allowed.

Moreover, as described in relation to step S105 in FIG. 8, before the magnitude of the charge current is actually restricted as a result of the first condition being fulfilled, the occupant is notified of the indication of this. Thus the frequency at which the magnitude of the charge current is restricted can be restrained, usability of the vehicle can be improved, and simultaneously, this is also advantageous to restraining the deterioration of the secondary battery by guiding the occupant to not allow fulfillment of the first condition.

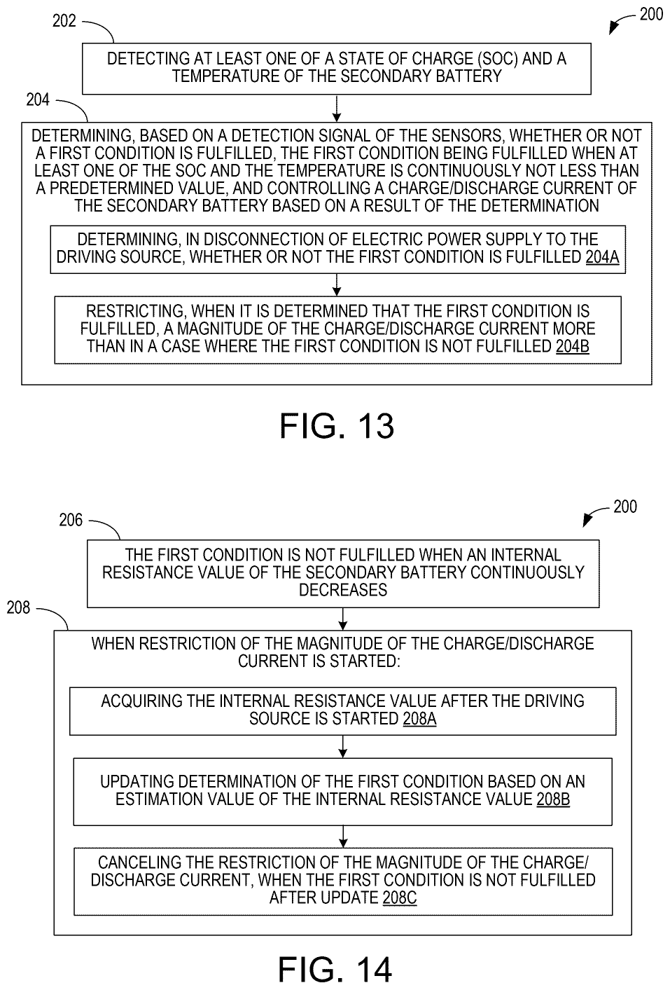

FIGS. 13-16 are flow charts of method 200 of controlling a secondary battery, according to one example implementation of the present disclosure. The method may be used with the vehicle described above or similar vehicles. The secondary battery can include a plurality of battery cells. A control apparatus supplies electric power from the plurality of battery cells to a driving source of the vehicle.

As shown in FIG. 13, method 200 includes, at 202, detecting at least one of a state of charge (SOC) and a temperature of the secondary battery. At 204, the method includes determining, based on a detection signal of the sensors, whether or not a first condition is fulfilled, the first condition being fulfilled when at least one of the SOC and the temperature is continuously not less than a predetermined value, and controlling a charge/discharge current of the secondary battery based on a result of the determination. The determining and controlling are performed at least in part by: at 204A, determining, in disconnection of electric power supply to the driving source, whether or not the first condition is fulfilled, and, at 204B, restricting, when it is determined that the first condition is fulfilled, a magnitude of the charge/discharge current more than in a case where the first condition is not fulfilled.

As shown in FIG. 14, in method 200, at 206, the first condition is not fulfilled when an internal resistance value of the secondary battery continuously decreases. At 208, when restriction of the magnitude of the charge/discharge current is started, the method further comprises: at 208A, acquiring the internal resistance value after the driving source is started, at 208B updating determination of the first condition based on an estimation value of the internal resistance value, and, at 208C, canceling the restriction of the magnitude of the charge/discharge current, when the first condition is not fulfilled after update.

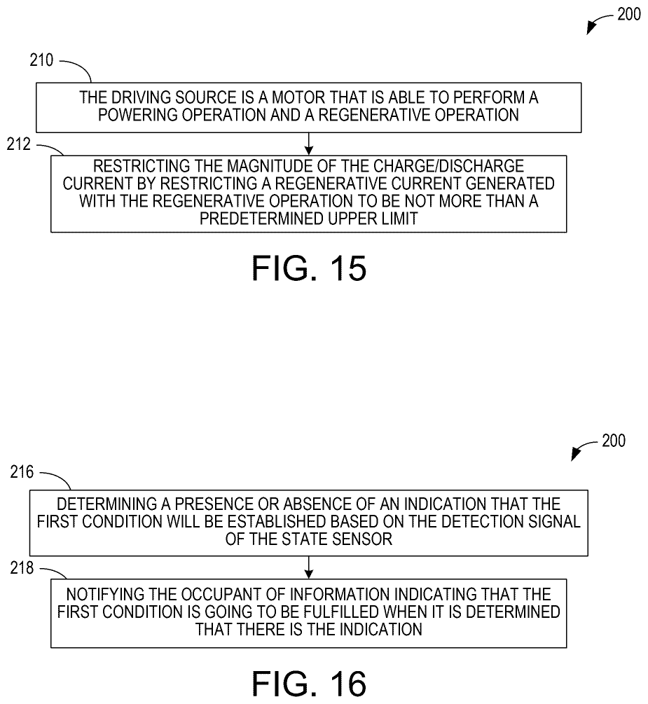

With reference to FIG. 15, in method 200, as shown at 210, the driving source can be a motor that is able to perform a powering operation and a regenerative operation. As shown at 212, the method can further comprise restricting the magnitude of the charge/discharge current by restricting a regenerative current generated with the regenerative operation to be not more than a predetermined upper limit.

As shown in FIG. 16, method 200 can further include, at 216, determining a presence or absence of an indication that the first condition will be established based on the detection signal of the state sensor. At 218, the method can include notifying the occupant of information indicating that the first condition is going to be fulfilled when it is determined that there is the indication.

It will be appreciated that method 200 may be implemented to achieve similar technical effects as the control apparatus described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1 control apparatus
3 driving source
31 motor
9 secondary battery
91 battery cell
100 controller
120 state sensor
121 SOC sensor
122 temperature sensor
V vehicle

1. A control apparatus for a secondary battery, the secondary battery including a plurality of battery cells, the control apparatus supplying electric power from the plurality of battery cells to a driving source of a vehicle, the control apparatus comprising:
a state sensor that includes one or more sensors configured to detect at least one of a state of charge (SOC) and a temperature of the secondary battery; and
a controller that determines, based on a detection signal of the sensors, whether or not a first condition is fulfilled, the first condition being fulfilled when at least one of the SOC and the temperature is continuously not less than a predetermined value, and controls a charge/discharge current of the secondary battery based on a result of the determination, wherein
the controller is configured to:
determine, in disconnection of electric power supply to the driving source, whether or not the first condition is fulfilled, and
restrict, when it is determined that the first condition is fulfilled, a magnitude of the charge/discharge current more than in a case where the first condition is not fulfilled.

2. The control apparatus according to claim 1, wherein
the first condition is not fulfilled when an internal resistance value of the secondary battery continuously decreases, and
when restriction of the magnitude of the charge/discharge current is started, the controller is further configured to:
acquire the internal resistance value after the driving source is started,
update determination of the first condition based on an estimation value of the internal resistance value, and
cancel, when the first condition is not fulfilled after update, the restriction of the magnitude of the charge/discharge current.

3. The control apparatus according to claim 1, wherein
the driving source is a motor that is able to perform a powering operation and a regenerative operation, and
the controller is further configured to restrict the magnitude of the charge/discharge current by restricting a regenerative current generated with the regenerative operation to be not more than a predetermined upper limit.

4. The control apparatus for the secondary battery according to claim 1, wherein
between fast charging, in which the vehicle receives an electric power supply not less than a predetermined electric power, and normal charging, in which the vehicle receives an electric power supply less than the predetermined electric power, the vehicle is able to receive electricity from power supply equipment at least through fast charging in order to charge the secondary battery; and
the controller restricts the magnitude of the charge/discharge current by restricting electricity supply through the fast charging.

5. The control apparatus for the secondary battery according to claim 1, comprising:
a notification unit that is electrically connected to the controller and notifies an occupant of the vehicle of information, wherein
the notification unit is configured to:
determine presence or absence of an indication that the first condition will be established based on the detection signal of the state sensor, and
notify the occupant of information indicating that the first condition is going to be fulfilled when it is determined that there is the indication.

6. The control apparatus for the secondary battery according to claim 1, wherein
the plurality of battery cells, each having a plate shape, are disposed to line up in a vehicle front-rear direction in a state of being bound from both front and rear sides of the plate shape,
each of the plurality of battery cells is disposed such that a longitudinal direction of the battery cell is aligned along a vehicle width direction, a transverse direction of the battery cell is aligned along a vehicle height direction, and a thickness direction of the battery cell is aligned along the vehicle front-rear direction,
a length of long sides of each of the plurality of battery cells in the longitudinal direction of the battery cells exceeds 50% of a vehicle width of the vehicle, and
at both ends of the long sides of each of the plurality of battery cells, tabs corresponding to a positive electrode and a negative electrode of the battery cell are disposed.

7. A method for controlling a secondary battery, the secondary battery including a plurality of battery cells, the control apparatus supplying electric power from the plurality of battery cells to a driving source of a vehicle, the method comprising:
detecting at least one of a state of charge (SOC) and a temperature of the secondary battery; and
determining, based on a detection signal of the sensors, whether or not a first condition is fulfilled, the first condition being fulfilled when at least one of the SOC and the temperature is continuously not less than a predetermined value, and controlling a charge/discharge current of the secondary battery based on a result of the determination, the determining and controlling being performed at least in part by:
determining, in disconnection of electric power supply to the driving source, whether or not the first condition is fulfilled, and
restricting, when it is determined that the first condition is fulfilled, a magnitude of the charge/discharge current more than in a case where the first condition is not fulfilled.

8. The method according to claim 7, wherein
the first condition is not fulfilled when an internal resistance value of the secondary battery continuously decreases, and
when restriction of the magnitude of the charge/discharge current is started, the method further comprises:
acquiring the internal resistance value after the driving source is started,
updating determination of the first condition based on an estimation value of the internal resistance value, and
canceling the restriction of the magnitude of the charge/discharge current, when the first condition is not fulfilled after update.

9. The method according to claim 8, wherein
the driving source is a motor that is able to perform a powering operation and a regenerative operation, and the method further comprises:
restricting the magnitude of the charge/discharge current by restricting a regenerative current generated with the regenerative operation to be not more than a predetermined upper limit.

10. The method according to claim 7, further comprising:
determining a presence or absence of an indication that the first condition will be established based on the detection signal of the state sensor, and
notifying the occupant of information indicating that the first condition is going to be fulfilled when it is determined that there is the indication.
